(19) United States
(12) Patent Application Publication
(10) Pub. No.: US 2008/0018607 A1
(43) Pub. Date: Jan. 24, 2008

(54) INPUT DEVICE AND MOBILE TERMINAL HAVING THE SAME

(76) Inventor: Won-Seok JOO, Seoul (KR)

Correspondence Address: BIRCH STEWART KOLASCH & BIRCH, PO BOX 747, FALLS CHURCH, VA, 22040-0747, US

(21) Appl. No.: 11/779,119

(22) Filed: Jul. 17, 2007

(30) Foreign Application Priority Data
Jul. 18, 2006 (KR) 10-2006-0067075

(51) Int. Cl. G06F 3/02

(52) U.S. Cl. 345/169

(57) ABSTRACT

An input device including a plurality of input keys configured to be operated in one of a push input method and a touch input method to input information, and a signal input unit disposed below the plurality of input keys and configured to generate a first signal when the plurality of input keys are operated in the push input method and one of the input keys is pushed, and to generate a second signal when the plurality of input keys are operated in the touch input method and one of the input keys is touched.

This application claims priority to Korean Application No. 10-2006-0067075, filed in Korea on Jul. 18, 2006, the entire contents of which is hereby incorporated in its entirety.

### BACKGROUND OF THE INVENTION

1. Field of the Invention

The present invention relates to a mobile terminal and corresponding input device, and more particularly to an input device that uses a single key in two types of input modes.

2. Description of the Related Art

FIG. 1 is a perspective view of a related art mobile terminal. As shown, the mobile terminal includes a first body 110 having a display 112 for displaying information, direction keys 114 and a menu key 116. The mobile terminal also includes a second body 120 mounted on the first body 110 such that the first and second bodies 110 and 120 can be opened and closed. Further, as shown, the second body 120 includes an input device 122.

The input device 122 includes a plurality of key buttons that can be pressed by a user to enter information into the terminal. For example, the keys may be pressed to enter a phone number, to input a text message, to input scheduling information, etc. The direction keys 114 and menu key 116 are used to navigate through different menus included in the terminal.

In addition, because there are now several additional features provided with the mobile terminal, besides the basic call service, the related art mobile terminal includes a plurality of input keys needed to operate the several features provided with the mobile terminal. Thus, the overall size of the mobile terminal is increased, and the area used by a display is reduced.

### SUMMARY OF THE INVENTION

Accordingly, one subject of the present invention is to address the above-noted and other problems.

Another object of the present invention is to provide an input device that has a reduced number of input keys by allowing a single key to input two types of signals.

Yet another object of the present invention is to provide a mobile terminal having an input device with a reduced number of input keys such that the mobile terminal has a sleek design and large display area.

To achieve these and other advantages and in accordance with the purpose of the present invention, as embodied and broadly described herein, the present invention provides in one aspect an input device including a plurality input keys configured to be operated in one of a push input method and a touch input method to input information, and a signal input unit disposed below the plurality of input keys and configured to generate a first signal when the plurality of keys are operated in the push input method and one of the input keys is pushed, and to generate a second signal when the plurality of keys are operated in the touch input method and one of the input keys is touched.

In another aspect, the present invention provides a mobile terminal including a first body having a display and a second body connected with the first body and having an input device configured to input information. Further, the input device includes a plurality input keys configured to be operated in one of a push input method and a touch input method to input information, and a signal input unit disposed below the plurality of input keys and configured to generate a first signal when the plurality of keys are operated in the push input method and one of the input keys is pushed, and to generate a second signal when the plurality of keys are operated in the touch input method and one of the input keys is touched.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a perspective view of a related art mobile terminal;

FIG. 2 is a perspective view of a mobile terminal according to one embodiment of the present invention;

FIG. 3 is a perspective view of a mobile terminal according to another embodiment of the present invention;

FIG. 4 is a sectional view of an input device according to an embodiment of the present invention;

FIG. 5 is a front view of input keys of an input device according to an embodiment of the present invention; and

FIG. 6 is a front view of input keys of an input device according to another embodiment of the present invention.

### DETAILED DESCRIPTION OF THE INVENTION

Reference will now be made in detail to the preferred embodiments of the present invention, examples of which are illustrated in the accompanying drawings. The same reference numerals will be used to describe the same or corresponding parts throughout the drawings.

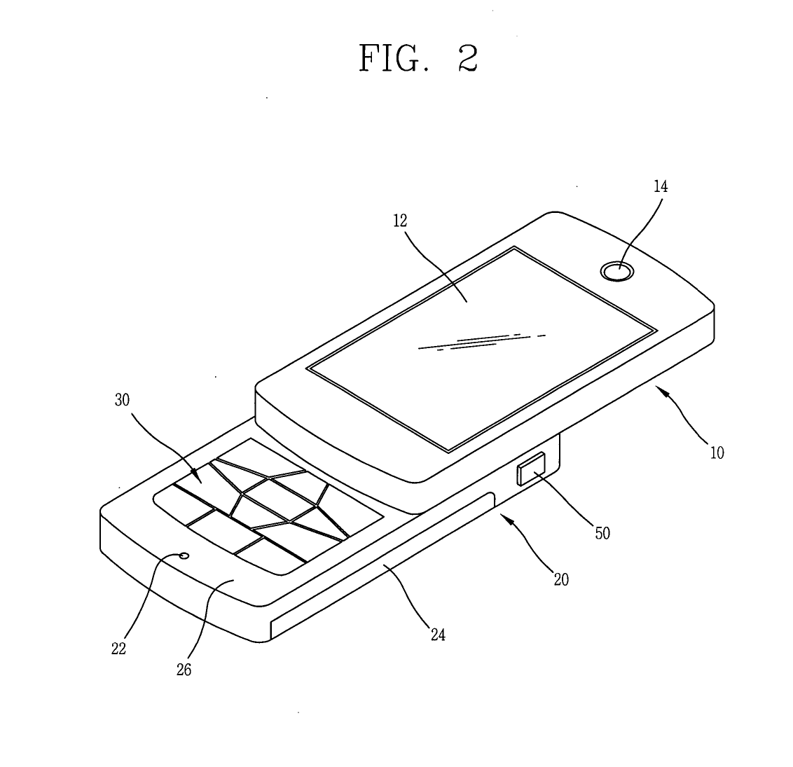

FIG. 2 is a perspective view of a mobile terminal according to one embodiment of the present invention. As shown, the mobile terminal includes a first body 10 having a display 12, and a second body 20 mounted on the first body 10 such that the first and second bodies 10 and 20 can be opened and closed. In addition, the terminal also includes an input device 30 mounted on a top portion of the second body 20, a batter 24 mounted on a lower portion of the second body 20, a case 26 surrounding the input device 30 and battery 24, and a microphone 22. Further, a speaker 14 is installed on the first body 10.

FIG. 2 illustrates a sliding type mobile terminal. However, the input device 30 is also applicable to other types of mobile terminals such as a folder type, a bar type and a swing type. Further, the input device 30 operates in two different modes; a touch input mode and a press input mode. The different modes of the input device 30 can be selected using a select switch 50 provided on a side of the second body 20. The different types of input modes will be described in more detail later.

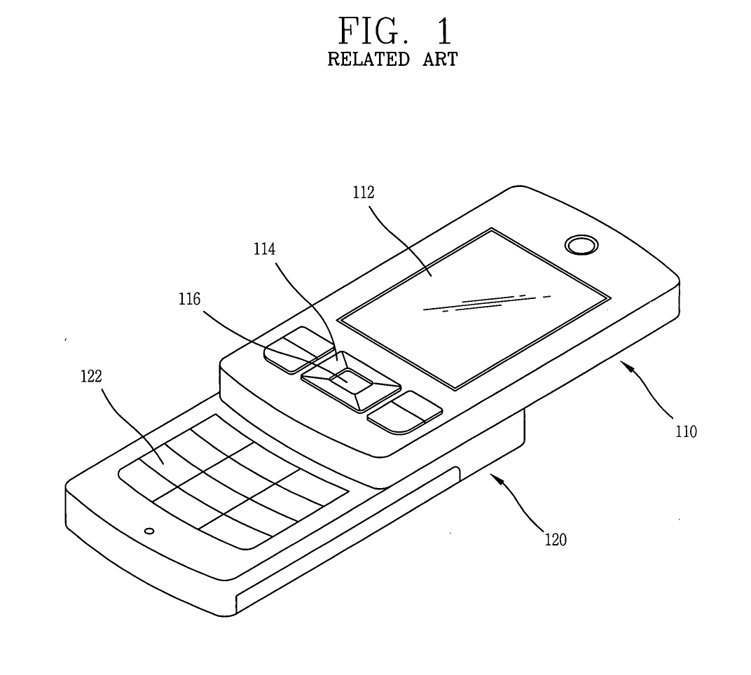

Further, as shown in FIG. 1, the display 12 covers substantially the entire top surface of the first body 10. That is, because the input unit 30 is able to operate in two different input modes, the function of the keys 114 and 116 shown in FIG. 1 may be included in the input unit 30 of the present invention. Therefore, the display 12 can be enlarged to cover substantially the entire top surface of the first body 10. In addition, because the input keys included in the input device 30 can be operated in two different input modes, the number of input operations is doubled compared to when the keys are only used in one input mode.

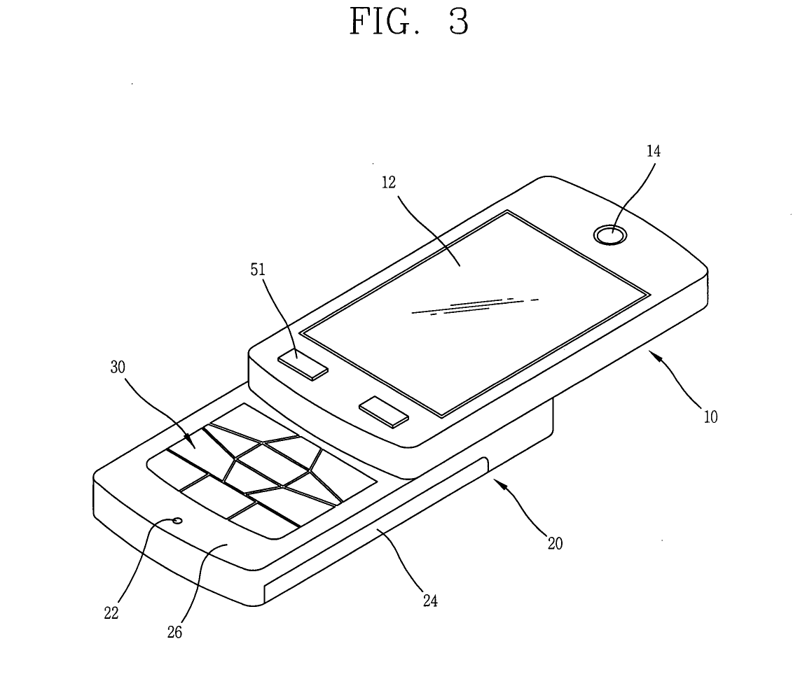

Note that FIG. 3 is similar to FIG. 2, except that the select switch 50 shown in FIG. 1 is replaced with a menu key 51 that may be selected to switch between the different input modes. For example, the menu key 51 installed at the first body 10 can be selected once to change the input mode of the input device 30 into a touch input mode, and can be selected again (or twice) to change the input mode of the input device 30 into a push input mode. As shown in FIG. 3, the menu key 51 covers only a small portion of the first body 10 such that the display 12 can be formed to cover substantially all of the first body 10. That is, the display 12 can be enlarged compared to the display 112 shown in FIG. 1.

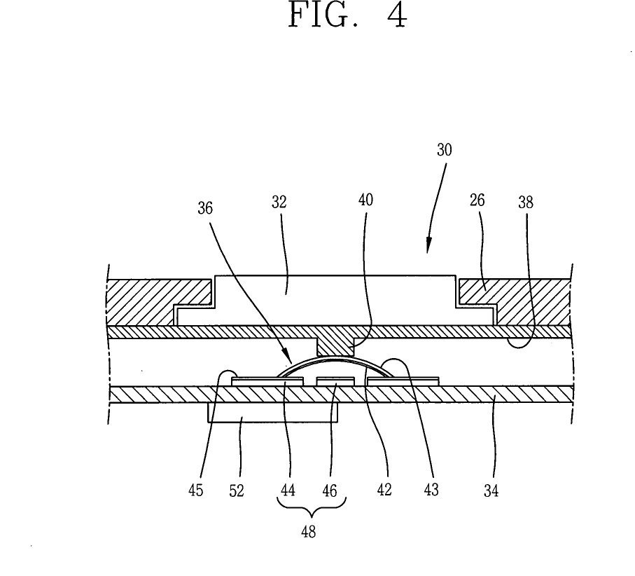

Next, FIG. 4 is a sectional view of the input device 30 according to an embodiment of the present invention. As shown in FIG. 4, the input device 30 includes input keys 32 that are exposed from the case 26 of the second body 20 (see also FIGS. 2 and 3), a signal input unit 36 installed on an upper surface of a circuit board 34 and for inputting two different types of input signals according to an operation of a particular key 32. Note that FIG. 4 only illustrates one key 32, but that the other keys are formed in a similar manner.

In addition, as shown in FIG. 4, the keys 32 are disposed on a front surface of the case 26 so as to be movable up and down. FIG. 4 also illustrates the signal input unit 36 including a dome switch 42 protruded in a concave form on an upper surface of the circuit board 34 and being disposed at a lower portion of the key 32 such that the dome switch 42 is pressed when the key 32 is pressed. That is, a pad 38 having a push protrusion portion 40 is mounted below the keys 32 such that when a particular key 32 is pressed, the push protrusion portion 40 presses against the dome switch 42 to thereby input a signal to the signal input unit 36 and the circuit board 34.

In more detail, an input pad 48 including a first input pad 46 disposed at a center of an inner side of the dome switch 42 and second input pads 44 disposed at certain intervals at a circumference of the first input pad 46 are formed on the circuit board 34. Thus, when the input unit 30 is set to the press input mode, the pressing of a particular key 32 pushes the dome switch 42 downwards against the first and second input pads 46 and 48 so as to input a signal to the circuit board 34. Further, the dome switch 42 and the input pad 48 are made of a metal or a copper material. Thus, a signal is generated when the key 32 is pressed.

In addition, as discussed above, the input device 30 can be operated in two different types of input modes (i.e., the press input mode and the touch input mode) by selecting the select switch 50 shown in FIG. 1 or the menu key 51 shown in FIG. 3. To operate the input device 30 in the touch input mode, the dome switch 42 includes a touch sensing unit 43. A touch sensing unit 45 is also formed on the input pad 48 such that when a particular key 32 is touched by a user (e.g., using his or her finger), a frequency period of the touch sensing unit 43 changes according to an influence of capacitance at the contacted portion.

A drive circuit element 52 installed at the circuit board 34 also operates in conjunction with the select switch key 50 in FIG. 2 and the menu key 51 in FIG. 1 to thereby turn on or off the touch sensing mode. Therefore, when the input device 30 is set as a touching input device, and a key 32 is touched, a signal is input to the circuit board 43 based on a capacitance type input method. In addition, the switch key 50 and menu key 51 can have other structures so long as it changes one of the push mode and the touch mode according to a user selection.

Thus, according to an embodiment of the present invention, when the input device 30 is set in the push input method and a key 32 is pushed, the pressed key 32 inputs a first signal to the signal input unit 36, and when the input device 30 is set in the touch input mode and a key 32 is touched, the touched key 32 inputs a second signal.

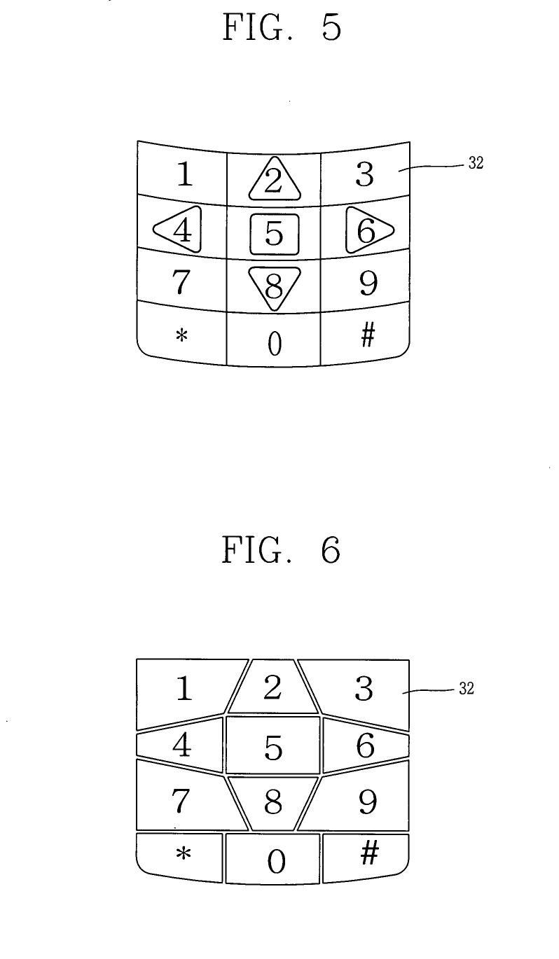

FIG. 5 is a front view of input keys of an input device according to an embodiment of the present invention. As shown in FIG. 5, only some of the input keys are designated as being able to operate in the two different types of input modes. In more detail, the keys “2”, “4”, “5”, “6” and “8” among the keys 32 are designated being able to be operated in both input modes. The other keys 32 are used as general keys and operate only in a single input mode (i.e., a touch or press input mode).

Further, as shown in FIG. 5, the keys 32 that are able to operate in both input modes have a different design than the other general keys such that a user can easily determined what keys 32 are able to operate in both input modes. In the embodiment shown in FIG. 5, the keys 32 that are able to operate in both input modes have an arrow shape surrounding the corresponding number. For example, the number “2” positioned at an upper portion of the input device 30 may having an upward arrow design to indicate to the user that the number “2” key may also be used as a direction key for moving a pointer in the upward direction. A similar concept applies to the keys “4”, “6” and “8” (i.e., to indicate to the user that they keys “4”, “6” and “8” may also be used as left, down and right direction keys, respectively). The middle key “5” may also include a square shape design to indicate to the user that the key “5” may also be used as an OK key or Enter Key.

FIG. 6 illustrates another embodiment for distinguishing keys 32 that may be operated in both input modes. As shown in FIG. 6, the keys 32 have an exterior shape corresponding to the particular additional function. For example, the key “2” has an upward arrow exterior shape indicating to the user the key “2” may also be used as an upward directional arrow key. A similar concept applies to the keys “4”, “6” and “8”. The key “5” has a square external shape indicating to the user that the key “5” may also be operated as an OK or Enter key.

Further, keys 32 that may be operated in both input modes may have a different color from the general keys, so that the user can easily recognize what keys may be operated in both modes. The lighting of the keys may also be different to indicate what keys may be operated in both input modes. For example, keys that may be operated in both input modes may include flashing lights or a different color light.

Further, the above description illustrates the keys 32 being used as directional keys and an OK/Enter key. However, other input functions may be assigned to the keys 32 that can be operated in both input modes.

An operation of the input device according to the present invention will now be described in more detail.

First, when the input device 30 is set as a push type input device, the touch sensing mode is changed to an OFF state. Accordingly, when the keys 32 are operated according to the push method, the push protrusion 40 presses against the dome switch 36. Then, the first and second input pads 46 and 44 are electrically connected according to the operation of the dome switch 42 to input a first signal.

In addition, when the input device is set to a touch type input device via the select switch 50 or the menu key 45, the drive circuit element 52 turns on the touch sensing mode. In this state, when the user touches the keys 32, a frequency period of the touch sensing units 43 and 45 formed at the dome switch 42 and the input pad 48 is converted according to an influence of capacitance around the keys to input a second signal.

As so far described, the mobile terminal according to the present invention has the several advantages because signals can be input according to both the push type and the touch type method using the single input device. Thus, the number of input key buttons can be reduced, the terminal can be compact and the display can be enlarged.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. An input device comprising:
a plurality input keys configured to be operated in one of a push input method and a touch input method to input information; and
a signal input unit disposed below the plurality of input keys and configured to generate a first signal when the plurality of input keys are operated in the push input method and one of the input keys is pushed, and to generate a second signal when the plurality of input keys are operated in the touch input method and one of the input keys is touched.

2. The device of claim 1, further comprising:
a circuit board including the signal input unit and configured to receive the first and second generated signals from the signal input unit and generate control signals for operating an apparatus including the input device based on the received first and second signals; and
a mode conversion unit configured to change between the plurality of input keys being operated in the touch input method and the push input method.

3. The device of claim 2, wherein the mode conversion unit comprises a select switch or a menu key that is different than the plurality of input keys.

4. The device of claim 1, further comprising:
a pad mounted on a lower surface of the plurality of input keys, said pad having a push protrusion formed on a lower surface of the pad at a position corresponding to each input key and configured to press the signal input unit when a corresponding input key is pressed.

5. The device of claim 2, wherein the signal input unit includes input pads mounted on the circuit board and dome switches configured to electrically connect the input pads when a corresponding input key is pressed.

6. The device of claim 5, wherein the input pads include first, second and third input pads for each input key,
wherein the dome switches are arranged to be below each of the plurality of input keys, one end of the dome switch contacting the first input pad and the other end of the dome switch contacting the third input pad when a corresponding key is not pressed, and
wherein the second input pad is disposed between the first and third input pads and the dome switch contacts the second pad when the corresponding input key is pressed to make electrical connection between the first, second and third input pads and thereby generate the first signal.

7. The device of claim 5, further comprising:
a touch sensing unit configured to generate the second signal according to a capacitance method when the plurality of input keys are operated in the touch method and a corresponding input key is touched.

8. The device of claim 7, wherein the touch sensing unit is disposed on the input pads and the dome switches.

9. A mobile terminal, comprising:
a first body having a display; and
a second body connected with the first body and having an input device for inputting information,
wherein the input device comprises:
a plurality of input keys configured to be operated in one of a push input method and a touch input method to input information; and
a signal input unit disposed below the plurality of input keys and configured to generate a first signal when the plurality of input keys are operated in the push input method and one of the input keys is pushed, and to generate a second signal when the plurality of input keys are operated in the touch input method and one of the input keys is touched.

10. The mobile terminal of claim 9, wherein the input device further comprises:
a circuit board including the signal input unit and configured to receive the first and second generated signals from the signal input unit and generate control signals for operating the mobile terminal based on the received first and second signals; and
a mode conversion unit configured to change between the plurality of input keys being operated in the touch input method and the push input method.

11. The mobile terminal of claim 10, wherein the mode conversion unit comprises a select switch mounted on the second body or a menu key mounted on the first body.

12. The mobile terminal of claim 9, wherein the input device further comprises general keys that are operated only in a single mode, and
wherein the plurality of input keys that are operated in the press or touch input mode are visually distinguished from the general keys.

13. The mobile terminal of claim 12, wherein the plurality of input keys that are operated in the press or touch input mode have a different shape from the general keys so as to visually distinguish the plurality of input keys that are operated in the press or touch input mode from the general keys.

14. The mobile terminal of claim 13, wherein the shape of the input keys that are operated in the press or touch input mode identifies an operation performed when the input keys are pressed or touched.

15. The mobile terminal of claim 12, wherein the plurality of input keys that are operated in the press or touch input mode have a different design from the general keys so as to visually distinguish the plurality of input keys that are operated in the press or touch input mode from the general keys.

16. The mobile terminal of claim 9, wherein the input device further comprises:
a pad mounted on a lower surface of the plurality of input keys, said pad having a push protrusion formed on a lower surface of the pad at a position corresponding to each input key and configured to press the signal input unit when a corresponding input key is pressed.

17. The mobile terminal of claim 10, wherein the signal input unit includes input pads mounted on the circuit board and dome switches configured to electrically connect the input pads when a corresponding input key is pressed.

18. The mobile terminal of claim 17, wherein the input pads include first, second and third input pads for each input key.
wherein the dome switches are arranged to be below each of the plurality of input keys, one end of the dome switch contacting the first input pad and the other end of the dome switch contacting the third input pad when a corresponding key is not pressed, and
wherein the second input pad is disposed between the first and third input pads and the dome switch contacts the second pad when the corresponding input key is pressed to make electrical connection between the first, second and third input pads and thereby generate the first signal.

19. The mobile terminal of claim 17, wherein the input device further includes a touch sensing unit configured to generate the second signal according to a capacitance method when the plurality of input keys are operated in the touch method and a corresponding input key is touched.

20. The mobile terminal of claim 19, wherein the touch sensing unit is disposed on the input pads and the dome switches.
